(19) United States
(12) Patent Application Publication
(10) Pub. No.: US 2009/0173556 A1
(43) Pub. Date: Jul. 9, 2009

(54) Transport Means

(76) Inventor: Svetlana Anatolevna Sokolova, Moskovskaya obl (RU)

Correspondence Address: THE NATH LAW GROUP, 112 South West Street, Alexandria, VA, 22314, US

(21) Appl. No.: 12/227,391

(22) PCT Filed: May 25, 2006
(86) PCT No.: PCT/RU2006/000264

§ 371 Date: Nov. 14, 2008

(30) Foreign Application Priority Data
May 17, 2006 (RU) 2006116901

(51) Int. Cl. B60W 10/08

(52) U.S. Cl. 180/65.265

(57) ABSTRACT

The invention relates to transport engineering and can be used for transport means provided with control members embodied in the form of at least one pedal controllable by the right foot of a driver, in particular in tramways, trollyebusses and cars provided with an automatic or semiautomatic gearbox etc. The inventive transport means comprises drive control members embodied in the form at least of one pedal actuatable by the right foot of the driver of the transport means and an additional pedal actuatable by the left foot thereof. Said additional pedal is embodied in the form of a simulating pedal and is provided with a unit for producing a power load on the transport means driver's left foot when it interacts with the simulating pedal. Said invention makes it possible to improve the physiological conditions of the transport means driver by balancing the physical load applied to the lower limbs (right and left feet) of the transport means driver during the transport means control.

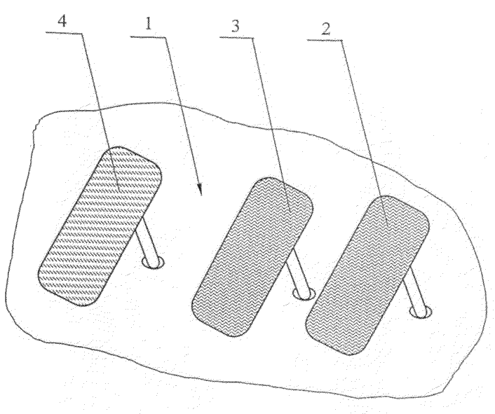

### FIELD OF THE UTILITY MODEL

This utility model relates to the field of transportation and may be used in vehicles having movement controls made as at least one pedal actuated by the right foot of the driver, especially in tramways, trolleybuses, cars with automatic or semi-automatic transmission, etc.

### PRIOR ART

A device for controlling a traction drive in city electric transport is known, which comprises an arm coupled with the driver's pedal controlling a controller (SU 182188 B 61 N, 1966). In this device the pedal is a means for controlling speed of a vehicle.

The closest to this utility model as to the technical essence and the achieved effect is a vehicle comprising movement controls made as at least one pedal actuated by the right foot of the vehicle driver and one additional pedal actuated by the left foot of the vehicle driver (RU 2173875, G 05 G 1/14, Sep. 20, 2001). The additional pedal in this known device is made as a brake pedal capable of directly acting on a brake cylinder. The additional pedal in the known device is intended for functioning mainly in emergencies, since its availability precludes the necessity of moving the driver's right foot from the accelerator pedal to the main brake pedal, thus reducing the time necessary for actuating the brake system of a vehicle.

Thus, a disadvantage of known vehicles having movement controls actuated mainly by the right foot of a vehicle driver is that there exists a significant difference in physical loads to the right foot and the left foot of a vehicle driver, which negatively influences the general physiological state of a vehicle driver. It is of especial importance for professional vehicle drivers.

### DESCRIPTION OF THE UTILITY MODEL

The task of this utility model is to develop and provide a vehicle comprising movement controls actuated mainly by the right foot of a driver and having improved performance.

By fulfilling this task a technical effect may be achieved which consists in improving the physiological state of a vehicle driver due to providing a possibility of equalizing physical loads to the lower extremities (the right foot and the left foot) of a vehicle driver when driving a vehicle.

For achieving the said technical effect in a vehicle comprising movement controls made as, at least, one pedal actuated by the right foot of a vehicle driver and one additional pedal actuated by the left foot of a vehicle driver, the said additional pedal is made as a pedal simulator and provided with a means intended for generating a power load to the left foot of a vehicle driver when the pedal simulator and the left foot of a vehicle driver interact.

A distinctive feature of the claimed utility model is that the additional pedal is made as a pedal simulator and provided with a means intended for generating a power load to the left foot of a vehicle driver when the pedal simulator and the left foot of a vehicle driver interact. In the result, when driving a vehicle a driver is capable of increasing a physical load to the left foot to a level of physical load exerted on his right foot, which significantly reduces “one-sided” development of his lower extremities.

It is preferred that a means intended for generating a power load to the left foot of a vehicle driver is made as a mechanical brake for simulator pedal movement, which may be made as:

a spring;

a torsion bar;

an arm which one end is connected to a pedal simulator and which other end is cinematically connected to a counterweight by a flexible coupling.

A means intended for generating a power load to the left foot of a vehicle driver may be also made as a hydraulic brake for simulator pedal movement or as a pneumatic brake for the simulator pedal movement.

### DESCRIPTION OF THE DRAWINGS

The Figure shows movement controls of a vehicle, which are actuated by the lower extremities (the right foot and the left foot) of a vehicle driver.

### DESCRIPTION OF A PREFERRED EMBODIMENTS OF THE UTILITY MODEL

A vehicle comprises movement controls made as, at least, one pedal actuated by the right foot of a vehicle driver. The movement controls comprise, in particular, an accelerator pedal 2 and a brake pedal 3. The accelerator pedal 2 and the brake pedal 3 are actuated by the right foot of a vehicle driver. The movement controls 1 also comprise an additional pedal simulator 4 actuated by the left foot of a vehicle driver. The pedal simulator 4 is provided with a means (not shown in the drawing) intended for generating a power load to the left foot of a vehicle driver when the pedal simulator and the left foot of a vehicle driver interact. The means for generating a power load to the left foot of a vehicle driver is made, e.g., as a mechanical brake for movement of the pedal simulator 4. The mechanical brake for the pedal simulator is made as a spring, a torsion bar, an arm which one end is connected to the pedal simulator and which other end is cinematically connected to a counterweight by a flexible coupling (not shown in the drawing). The means for generating a power load to the left foot of a vehicle driver mat be also made as a hydraulic brake for the pedal simulator movement or as a pneumatic brake for the pedal simulator movement. For a structure of the means intended for generating a power load to the left foot of a vehicle driver any known power structure of a gym apparatus used in gyms.

The device according to this utility model functions as follows.

A driver controls vehicle movement by using movement controls 1 actuated by the right foot as well as other controls, such as a steering wheel, a manual controller, etc. For controlling the speed of a vehicle its driver pushes the accelerator pedal 2 or the brake pedal 3, thus changing the vehicle speed. At the same time the left foot of the vehicle driver does not function, practically remaining immovable. The availability of the additional pedal simulator 4 enables to exert a power load to the left foot of the vehicle driver also, by periodically pushing it in order the driver's left foot also takes a physical load. Thus, the blood circulation in the driver's organism is generally improved. In principle, it is possible to install a second pedal simulator. In such a case a vehicle driver may act on the pedal simulators synchronously by the left foot and the right foot.

At least one additional pedal simulator 4 may be made as an autonomous drive (engine, electric generator, etc.) intended for operation of various assemblies of a vehicle, since it is provided with a means intended for generating a power load to the left foot of a vehicle driver when interaction exists between a pedal simulator and the left foot of a vehicle driver. Actually, the pedal simulator 4 may be connected to an autonomous pump feeding a liquid to windows or to an electric generator for charging the vehicle accumulator when the vehicle is stopped, etc.

A pedal simulator according to this utility model may be produced as a separate additional piece of equipment for a vehicle and installed in a place convenient for a driver.

It is obvious that the given examples of using the device according to this utility model do not limit all possible variants of its use.

The claimed utility model may be produced at any known equipment with the use of known technologies and does not require principally new equipment and tools.

### INDUSTRIAL APPLICABILITY

This utility model is industrially applicable and may be most beneficially used in vehicles having movement controls made as, at least, one pedal actuated by the right foot of a driver, especially in tramways, trolleybuses, cars having an automatic or semi-automatic transmission, etc.

What is claimed is:

1. A vehicle comprising movement controls made as, at least, one pedal actuated by the right foot of a vehicle driver, and one additional pedal actuated by the left foot of a vehicle driver, characterized in that said additional pedal is made as a pedal simulator and is provided with a means intended for generating a power load to the left foot of a vehicle driver when said pedal simulator and the left foot of a vehicle driver interact.

2. A vehicle according to claim 1, characterized in that said means for generating a power load to the left foot of a vehicle driver is made as a mechanical brake for the pedal simulator movement.

3. A vehicle according to claim 2, characterized in that said mechanical brake for the pedal simulator movement is made in the form of a spring.

4. A vehicle according to claim 2, characterized in that said mechanical brake for the pedal simulator movement is made in the form of a torsion bar.

5. A vehicle according to claim 2, characterized in that said mechanical brake for the pedal simulator movement is made in the form of an arm which one end is connected to said pedal simulator and the other end is cinematically connected to a counterweight by a flexible coupling.

6. A vehicle according to claim 1, characterized in that said means for generating a power load to the left foot of a vehicle driver is made as a hydraulic brake for the pedal simulator movement.

7. A vehicle according to claim 1, characterized in that said means for generating a power load to the left foot of a vehicle driver is made as a pneumatic brake for the pedal simulator movement.
